(19) United States
(12) Patent Application Publication
(10) Pub. No.: US 2026/0199055 A1
(43) Pub. Date: Jul. 16, 2026

(54) BONE LEVEL GUIDED DRILLS

(71) Applicant: Marc Paternina, New Hyde Park, NY (US)

(72) Inventor: Marc Paternina, New Hyde Park, NY (US)

(21) Appl. No.: 19/449,763

(22) Filed: Jan. 15, 2026

Related U.S. Application Data
(60) Provisional application No. 63/745,527, filed on Jan. 15, 2025.

(51) Int. Cl. A61C 1/08

(52) U.S. Cl. CPC A61C 1/084

(57) ABSTRACT

Described herein are examples of bone level guided drills including an engaging shaft; a guide shaft, and an active shaft, wherein the active shaft is configured for cutting, compressing, or torque-transmitting; the guide shaft is configured to connect the engaging shaft and the active shaft, wherein the guide shaft further includes a bone-level stopper configured to stop the action of the active shaft when the tissue or bone of the patient engages the bone-level stopper.

### CROSS REFERENCE TO RELATED APPLICATIONS

The present application claims priority to U.S. Provisional Patent Application No. 63/745,527 filed January 15, 2025 entitled “UNIVERSAL PRECISION BONE LEVEL GUIDED IMPLANT DRILLS FOR DENTAL PROCEDURES”. The entire contents of the above-listed application are hereby incorporated by reference for all purposes.

### BACKGROUND

The present invention relates to dental implantology and, more particularly, to guided surgical instruments and systems providing mechanical bone-level depth control and standardized axial precision for oral surgery, including implant osteotomy and delivery.

### BRIEF DESCRIPTION OF THE DRAWINGS

The present description will be understood more fully when viewed with the accompanying charts, drawings and data associated with various examples of bone level guided drills. The description is not meant to limit the bone level guided drills to specific examples. Rather, the specific examples depicted and described are provided for explanation and understanding of bone level guided drills. The drawings may be referred to as drawings, figures, and/or FIGs throughout the description.

FIG. 1 illustrates prior art guided drill products 1A, 1B, 1C and 1D.

FIG. 2 illustrates a bone level guided drill, according to an embodiment.

FIG. 3. illustrates internal view of the guide shaft of a bone level guided drill, according to an embodiment.

FIG. 4 illustrates a bone level guided drill with a straight drill active shaft, according to an embodiment.

FIG. 5 illustrates a bone level guided drill with an implant insertion active shaft, according to an embodiment.

FIG. 6 illustrates a bone level guided drill with a bone expander active shaft, according to an embodiment.

FIG. 7 illustrates a bone level guided drill with a tissue punch active shaft, according to an embodiment.

FIG. 8 illustrates a tapered shaping bone level guided drill, according to an embodiment.

FIG. 9 illustrates a bone level reference gauge according to an embodiment.

FIG. 10 illustrates an alternative view of a tapered active shaft, according to an embodiment.

FIG. 11 illustrates a bone level reference probe, according to an embodiment.

FIG. 12 illustrates a kit comprising multiple bone level guided drills and associated tools, according to an embodiment.

FIG. 13 illustrates a bone level guided drill being employed in the mouth of a patient, according to an embodiment.

FIG. 14 illustrates a bone level guided drill being employed in the mouth of a patient with a cut-away view of a guide sleeve, according to an embodiment.

### DETAILED DESCRIPTION

Bone level guided drills as disclosed herein will become better understood through a review of the following detailed description in conjunction with the figures. The detailed description and figures provide merely examples of the various embodiments of bone level guided drills. Many variations are contemplated for different embodiments and methods of use; however, for brevity and clarity, all the contemplated variations may not be individually described in the following detailed description. Those skilled in the art will understand how the disclosed examples may be varied, modified, and altered and not depart in substance from the scope of the examples described herein.

Conventional guided implant kits employ stop-rings, sleeve inserts, or external depth gauges to approximate final drilling depth. These external mechanisms are prone to manufacturing tolerance errors, guide flexure, and user variability. Conventional designs such as Straumann’s guided drill sleeves, Nobel Biocare’s pilot stop rings, and Dentsply Sirona’s depth-limiting spacers achieve partial control but depend on interchangeable spacers or manual calibration. None of the prior art products integrate a mechanical bone-level reference into the drill body itself, nor provide a unified system capable of performing drilling, expansion, insertion, and verification with identical vertical referencing.

There is a need for drill systems wherein depth control is intrinsic to the geometry of the instrument, such as a drill system possessing a differential diameter between the guide shaft and active shaft (wherein the diameter of the guide shaft is greater than the diameter of the active shaft), forming an automatic mechanical stop. Such an embodiment can eliminate auxiliary components, reduces cumulative error, and provides universal compatibility across existing surgical guide platforms.

Further, there is a need for guided surgical instruments that provide standardized depth control, axial orientation, and cortical referencing without dependence on external spacers, stop-rings, guide offsets, or manual calibration. Conventional systems rely on multi-component assemblies that accumulate tolerance stack-up, introduce variability between drill sizes, and require system-specific sleeves or proprietary drill keys. A unified drill design that incorporates bone-level referencing directly into the instrument body would reduce these sources of error, simplify workflow, and improve surgical reproducibility across diverse implant platforms.

Generally, conventional drill products are not configured to provide mechanical termination at the bone crest, nor do they maintain a consistent vertical reference across sequential drilling, shaping, expansion, and implant-delivery steps. These prior designs rely on interchangeable components that introduce depth discrepancies, allow over-penetration past the intended drill depth, or require visual alignment that becomes unreliable in limited-visibility surgical fields. Conventional drills lack an integrated architecture that ensures the same stopping point for the drill is reproduced for each instrument in the sequence, thereby limiting accuracy, increasing chair time, and elevating the risk of complications arising from deviations between the planned and executed osteotomy depth.

Embodiments of the present invention can provide a set of guided dental instruments including a proximal engaging shaft; a guide shaft configured for sleeve-based trajectory control; an active shaft, wherein the active shaft is configured for cutting, compressing, or torque-transmitting; and an integrated bone-level stopper configured to providing automatic mechanical termination at surface of the bone or tissue.

Embodiments of the present invention can be configured to perform distinct tasks, such as drilling, shaping, expanding, tissue punching, implant insertion, and/or bone-level measurement. Further the embodiments can be configured to maintain identical reference geometry and depth. This standardization allows surgeons to reproduce digital surgical plans with exceptional precision and repeatability.

Embodiments can provide integrated depth control, which eliminates external stops or gauges. Embodiments can provide a bone level stopper in combination with the guide shaft and the active shaft, causing the bone level guided drill to terminate at the bone surface. Prior systems depend on externally attached rings or spacers, which introduce variability and require user adjustment. By embedding the bone level stopper into the drill body, the drilling depth becomes consistent and self-regulating without reliance on accessory components.

Embodiments can provide universal system compatibility across multiple implant platforms. The engaging shaft and guide shaft can be configured to fit common handpieces and guide sleeves used across many implant systems. Conventional drills are often designed to function only with a single proprietary platform. The present invention allows is configured to interface with diverse systems without requiring custom adapters or system-specific sleeves.

Embodiments can provide universal compatibility with diverse implant and guide systems. Embodiments can include a free-glide guide shaft, which can be configured to operate within a wide range of guide sleeves used in digital and analog workflows. Prior art instruments frequently require unique sleeves, inserts, or keys for each manufacturer, whereas the present invention can operates within existing sleeve dimensions, reducing the need for dedicated components.

Embodiments can provide reduced procedural time through guided automation of depth limits. Embodiments of the present invention can be configured to stops automatically at an intended bone level depth. The operator or user does not need to pause for depth verification or adjust external stoppers. Traditional workflows require repeated measurements or component changes, extending surgical time. The bone-level stopper of the present invention reduces reliance on manual checks and decreases the overall number of operative steps.

Embodiments can provide enhanced safety via floss-retrieval eyelets and controlled free-glide mechanisms. The optional retrieval eyelet can allow attachment of floss or a safety tether to prevent accidental aspiration or loss of the bone level guided drill or accompanying instruments and tools. The guide shaft can stabilize the bone level guided drill within the guide sleeve, reducing lateral drift and unintended movement. Conventional tools lacking these features may be more susceptible to displacement or accidental detachment during surgery.

Embodiments can provide standardized drill depths improving surgical outcomes. The bone level stopper can be configured to allow various drills to reach the same depth regardless of diameter or function of the drill (or active feature). Conventional systems often depend on separate components for each drill, leading to slight variations in final depth. Consistent depth contributes to predictable implant positioning and more reliable outcomes.

Embodiments can provide modular flexibility supporting drilling, expansion, insertion, and measurement in a single bone level guided drill. Multiple active shafts employing various active features, for example, cutting drills, expanders, punches, and gauges, can be configured to operate and be combined with a single guide shaft. These active shafts can be interchanged without altering other elements of the bone level guided drill. Many existing kits use different tool configurations for different functions that require recalibration or depth compensation.

Embodiments can provide integrated depth control without an external stop. The bone level guided drill is configured with a bone level stopper to regulate the drill depth. External stop rings in conventional systems may loosen, shift, or be installed incorrectly, creating opportunities for over-penetration. The present invention resolves these deficiencies by removing the dependency on removable components, such as external stops and/or spacers.

Embodiments can provide enhanced precision and repeatability. The mechanical interaction between the guide shaft via the bone level stopper and the surface of the bone or tissue creates a repeatable endpoint for each bone level guided drill. Conventional systems that rely on user visualization or tactile judgment may experience inconsistency, especially in reduced-visibility conditions. The present invention provides a controlled and reproducible drill depth.

Embodiments can provide reduced inventory and simplified workflow via modular interchangeability. Because the bone level guided drills share a common guide shaft and bone level stopper, a single universal sleeve system can be used for multiple drill types. In contrast, many existing systems require different sleeves or inserts for each drill diameter or active feature of the active shaft. This reduces the number of drill components needed and simplifies instrument management.

Embodiments can provide improved safety through retrieval eyelets and anti-slip surfaces. Textured or flattened gripping components can reduce the chance of slippage when using torque drivers, and the eyelet can provide a tether point for controlled manipulation. Convention tools lacking these features may be more prone to accidental rotation or unintended release during instrument exchange.

Embodiments can provide improved clinical efficiency, for example shorter surgery time and minimized bone/soft-tissue trauma. By combining depth control, axial stability, and modular functionality, the bone level guided drill can reduces the number of steps required for surgery. The free-glide action and cooling grooves can reduce friction and heat generation. Conventional workflows often require multiple depth checks or separate shaping drills, which can further increase trauma to the patient and extend surgery time.

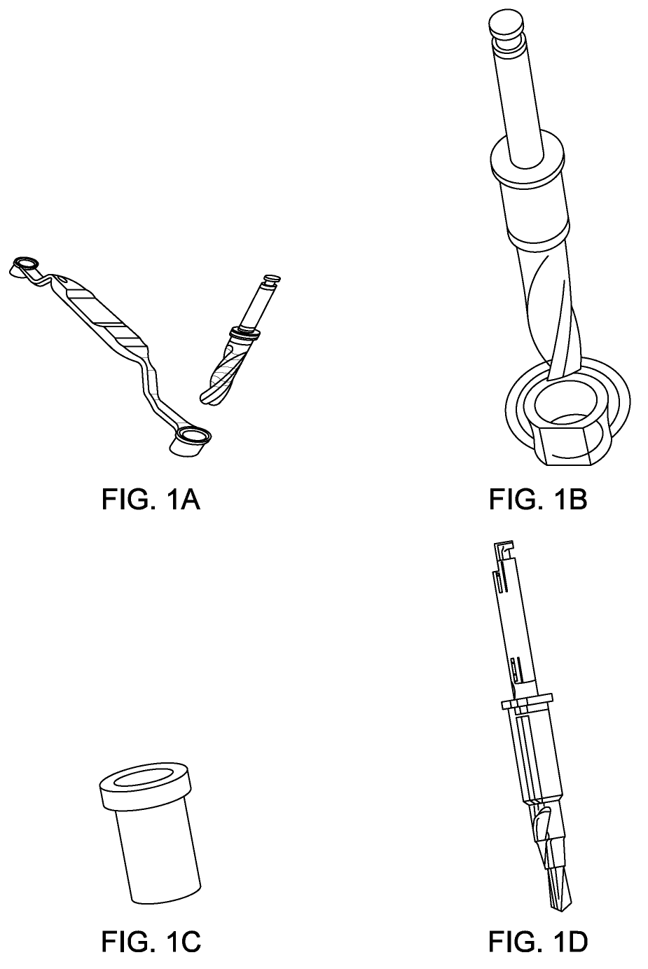

FIG. 1 illustrates prior art drill systems including a guide spoon (FIG. 1a), a guided dental implant drill (FIG. 1b), a surgical guide sleeve (FIG. 1c), and an alternative guided drill (FIG. 1d).

FIG. 1a illustrates a guide spoon, configured as an adapter sleeve insertable into a master sleeve of a surgical guide. The guide spoon reduces the effective internal diameter of the master sleeve to correspond to the diameter of a selected sequential drill, thereby guiding drill position, angulation, and depth during surgery. This prior art configuration introduces an additional intermediate component between the surgical guide and the drill, increasing system complexity and handling steps and potentially increasing the margin for user error.

FIG. 1b illustrates a prior art guided drill incorporating an integrated depth-limiting feature positioned below the drill component. In this prior art configuration, depth control is dependent on preoperative calculations that account for soft tissue thickness and the distance between the superior edge of the guide sleeve and the bone surface. These calculations are user-dependent and may introduce inaccuracies in the oral surgery, such as the osteotomy depth when compared to systems in which depth control is established directly at the bone level.

FIG. 1c illustrates a surgical guide sleeve configured to control drill alignment and depth during guided osteotomy preparation. Depth regulation is determined by sleeve height and drill interaction with the sleeve rather than by a bone-level stopper as disclosed in the present application.

FIG. 1d illustrates an alternate guided drill in which a depth-limiting component is positioned on the drill and configured to interact with a surgical guide sleeve to limit drilling depth. Similar to other prior art configurations, depth control is dependent on the positional relationship between the drill, the guide sleeve, and overlying soft tissue rather than on a bone level stopper as disclosed in the present application.

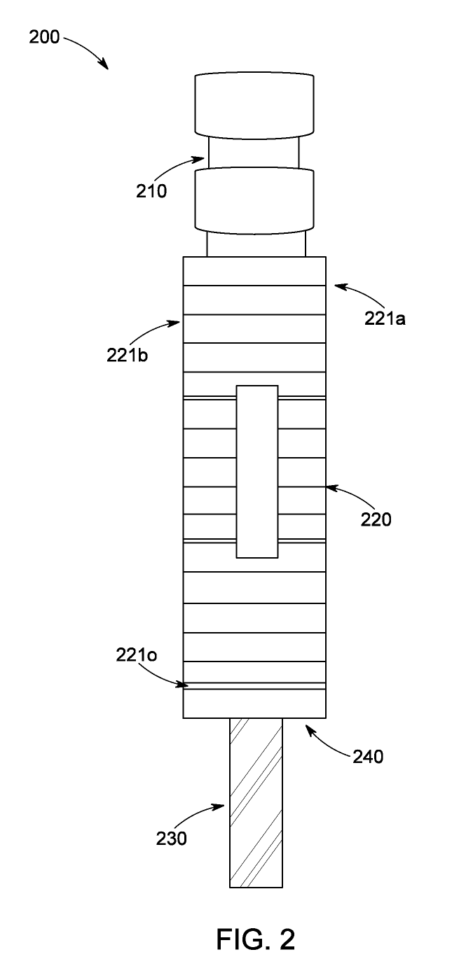

FIG. 2 illustrates a bone level guided drill 200, according to an embodiment. The bone level guided drill 200 includes an engaging shaft 210, a guide shaft 220, an active shaft 230, and a bone-level stopper 240. Optionally, the bone level guided drill 200 can further include an eyelet 250.

The engaging shaft 210 is located at an end of the bone level guided drill 200 proximal to the user (and the driving instrument, such as a surgical handle or surgical handpiece) and is configured to provide a mechanical interface or connection between the bone level guided drill 200 and the user via a driving instrument (not shown). The engaging shaft 210 can be configured in variable lengths, diameters, and cross-sectional geometries to ensure universal compatibility with a wide range of driving instruments, including but not limited to: engine-driven contra-angle handpieces; torque-limiting mechanical wrenches; and manual ratchet wrenches of various head geometries and drive sizes.

The term head, as used herein, can refer to an engaging portion of the driving instrument, for example the head can be the end of the driving instrument that is configured to interface with a corresponding engaging shaft on the bone level guided drill 200. The head can be in various configurations, including, but not limited to hex, square, star, or other profiles.

The term driving instrument is used herein refers to any tool configured to transmit rotational torque or mechanical motion to the engaging shaft 210 of the bone level guided drill 200. The term driving instrument includes, but is not limited to, engine-driven contra-angle dental handpieces, torque-limiting mechanical dental wrenches, and/or manual or ratcheting dental driver tools. The preceding tools can be collectively referred to as driving instruments. As defined above, driving instruments include any dental instrument configured to rotate, actuate, or mechanically drive the engaging shaft of the bone level guided drill 200.

The engaging shaft 210 can be provided with various driving instruments connectors to allow the engaging shaft 210 to connect to the driving instrument. The driving instrument connector can include connection geometries such as standard geometries, ISO latch-type, square-drive, or friction-grip couplers. The driving instrument connector provides interchangeability across multiple implant systems and different manufacturers.

The engaging shaft 210 can further include a locking component (not shown), such as a circumferential detent groove or retention slot, can be provided to engage a spring-loaded chuck or locking pin within the driving instrument. The locking component can prevent accidental disengagement of the engaging shaft 210 and the driving instrument during use. The locking component can be integrated into the engaging shaft 210 and provide a secure mechanical connection between the engaging shaft 210 and the driving instrument. The locking component can be configured to prevent the drill from unintentionally loosening or detaching during operation, providing stability, safety, and reliable torque transmission during operation of the bone level guided drill 200.

Optionally, the engaging shaft 210 can include a grip enhancer (not shown), such as flattened anti-slip faces, micro-knurling, or textured bands to improve manual grip when using driving instruments, such as torque or ratchet drivers. The grip enhancer can provide enhanced tactile control and improve positional accuracy when the bone level guided drill 200 is connected to or withdrawn from the driving instrument

Embodiments of the engaging shaft 210 can be coupled, attached, affixed, and/or connected to the guide shaft 220 of the bone level guided drill 200 via a guide shaft-engaging shaft connector (not shown). The guide shaft-engaging shaft connector can be threaded, a bayonet, and/or a press-fit coupling. The guide shaft-engaging shaft connector can be configured to allow the bone level guided drill 200 to accept various configurations of engaging shafts 210.

The engaging shaft 210 can be prepared and/or fabricated from surgical-grade stainless steel (such as AISI 420 or 440C), titanium alloy (such as Ti-6Al-4V), Tungsten Carbide, Zirconia and Titanium Nitride, and combinations thereof. The engaging shaft 210 can be configured to allow precision machining, hardening, passivation, and laser marking to ensure rotational stability.

The guide shaft 220 is a generally cylindrical portion of the bone level guided drill 200 which can be positioned between the engaging shaft 210 and the active shaft 230. The guide shaft 220 can be configured to glide freely within a corresponding guide sleeve (not shown) which can be integrated into a surgical guide (not shown), creating a friction-controlled, free-glide path based on a pre-determined drill path.

The drill path is determined using a pre-planned digital treatment workflow based on diagnostic data which can be obtained from the patient. The drill path is determined based on the treatment required by the patient. The diagnostic data can include, but is not limited to, cone beam computed tomography (CBCT) imaging and intraoral or optical surface scans. The diagnostic data can be combined with existing drill path datasets (for example drill path datasets stored in existing databases) to allow the user (dental clinician, oral surgeon, periodontics, and/or oral implantologists) to determine a three-dimensional position, angulation, and depth for a proposed dental implant prior to surgery. Once the drill path is finalized, software is employed to prepare a surgical guide (which is patient specific). The surgical guide is then prepared, often via 3D-printing, and placed intraorally with the patient prior to the procedure.

The guide sleeve (not shown) can be a cylindrical tube or bushing that can be built into or as part of a surgical guide. The guide sleeve is configured to direct and control the path of the bone level guided drill 200 during implant surgery. The guide shaft 220 can be configured to fit inside the guide sleeve. As the bone level guided drill 200 moves up and down, the guide sleeve maintains the bone level guided drill 200 in a centered and aligned position, preventing unwanted lateral movement. The guide sleeve ensures that the drilling trajectory follows the exact position, angulation, and depth indicated by the drill path. The guide sleeve provides a stable pathway, maintains correct angulation and position, ensures consistent, repeatable precision for the bone level guided drill 200, and prevents deviation from the drill path.

The bone level guided drill 200 and the guide sleeve are a matched pair. The guide shaft 220 is configured to “free-glide” within the guide sleeve with minimal clearance. The guide sleeve directs where the bone level guided drill 200 moves within the oral cavity of the patient.

The guide sleeve ensures the bone level guided drill 200 does not drift or wobble and maintains surgical accuracy.

During surgery, the user employes the surgical guide to replicate the drill path. To accomplish this, the bone level guided drill 200 is configured, and specifically, the guide shaft 220 is configured to travel within the guide sleeves along the drill path (including the planned angulation and depth).

The bone level guided drill 200 is configured to allow the device to traverse the guide sleeve completely from end to end of the guide sleeve without obstruction. The guide shaft 220 does not include a terminal stopper or protrusion that might restrict movement, allowing the bone level guided drill 200 to provide unobstructed movement. The unobstructed movement of the guide shaft 220 allows for smooth insertion, withdrawal, and depth adjustment under guided conditions, while maintaining strict angular and positional accuracy.

To accommodate surgical variability, the guide shaft 220 can be manufactured in multiple diameters and lengths, allowing compatibility with guide sleeves of differing internal dimensions and compensating for variations in soft-tissue or mucosal thickness.

Graduation markings 221a-o can be laser-etched, engraved, or micro-grooved along the surface of the guide shaft 220 to facilitate depth verification and to cross-reference with the drill path. Graduation markings 221a-o can be provided in millimeter steps, inches, or other measurements. The graduation markings 221a-o can provide the surgeon with an important visual reference for maintaining precise depth control throughout the surgery.

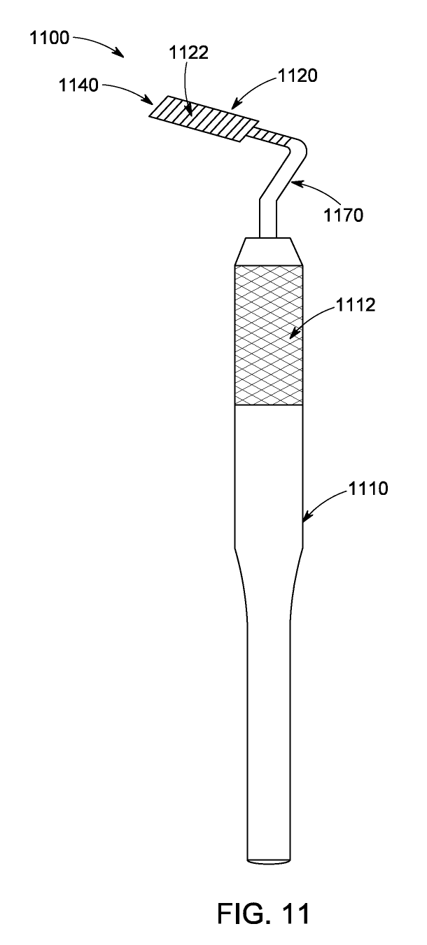

The guide shaft 220 can further optionally include guide shaft grooves (not shown), such as vertical or helicoidal grooves (see FIG. 11 discussed below), ranging from approximately 0.1 to 10 mm, 0.5 to 5 mm, and/or 0.33 mm to 4 mm in width and 0.1 to 10 mm, 0.5 to 5 mm, and/or 0.3 mm to 3 mm in depth. The guide shaft grooves can be incorporated in parallel or twisted relative to the long axis of the guide shaft 220. The guide shaft grooves are configured to provide enhanced cooling and gliding for the guide shaft 220, improving fluid flow and heat dissipation during surgery. The guide shaft grooves on the guide shaft 220 are configured to increase the available volume for cooling fluid compared to conventional guide shafts with flat surfaces. The added fluid space between the guide shaft 220 and the inner wall of the guide sleeve enhances lubrication, reduces friction and heat generation, and improves the overall glide performance of the bone level guided drill 200.

Dimensional tolerances between the guide shaft 220 and the corresponding guide sleeve may range from 0.02 mm to 0.05 mm, providing a passive yet stable fit that prevents binding of the guide shaft 220 to the guide sleeve, while maintaining angular precision throughout drill path. Dimensional tolerance refers to the clearance provided by size difference between the guide shaft 220 and the guide sleeve. The clearance can be configured to be between 0.01 and 0.10, 0.15 and 0.075, 0.02 mm and 0.05 mm, Preferably, the guide shaft 220 and the guide sleeve do not squeeze tightly against each other, preventing friction and binding. Additionally, the guide shaft 220 and the guide sleeve also are not far apart or loose, which preserves accuracy. The clearance should not be excessive, ensuring the guide shaft 220 remains laterally and angularly constrained to preserve positional accuracy during guided drilling procedures.

Embodiments of the guide shaft 220 surface can be treated with low-friction coatings, including, but not limited to, titanium nitride (TiN), diamond-like carbon (DLC), and/or physical vapor deposition (PVD) finishes, to enhance glide smoothness, reduce particulate generation, and minimize wear on both the guide shaft 220 and the guide sleeve during repeated sterilization cycles and surgery.

The active shaft 230 is the portion of the bone level guided drill 200 distal from the engaging shaft 210 and the driving instrument. The active shaft 230 is configured to engage directly with the patient, and more specifically the tooth or gums of the patient. The active shaft 230 can include a bone cutting, expansion, compression, or controlled bone displacement component to provide the action of the bone level guided drill 200 during surgery, for example osteotomy formation, the process of creating a hole in the bone where a dental implant will be placed. The active shaft 230 can further provide bone delivery and compaction in procedures such as crestal or vertical sinus lift augmentation.

The active shaft 230 can have various components that provide various dental objectives. The active shaft 230 can include components with helical, parabolic, or straight flutes structures. The active shaft 230 can be optimized for axial stability, torque efficiency, and effective debris evacuation under continuous irrigation. In certain embodiments, the active shaft 230 can include helical non-cutting flutes designed specifically for bone expansion and compression, allowing gradual lateral displacement and densification of trabecular bone rather than bone removal.

The active shaft 230 can be configured with various drill, implant, widening, impacting, insertion components depending on the surgical stage, including self-centering pilot tips for initial osteotomy penetration, flat-ended shaping tips for controlled apical advancement, and apically relieved or side-vented tips for final drilling or bone-delivery applications.

Embodiments of the active shaft 230 can include fluid delivery components, which can include internal coolant channels, radial irrigation ports, or micro-grooved evacuation tracks to enhance fluid delivery for the active shaft 230. In embodiment wherein the active shaft 230 includes a drill component the cutting surface of the drill component can be assisted by a fluid delivery component. More specifically, the fluid delivery component reduces heat generation and minimizing the risk of osteonecrosis, the death of bone tissue due to a lack of blood supply.

The active shaft 230 can further include active shaft depth markings, such as millimeter spaced marking, color-coded rings, or laser-engraved identifiers to assist the operator in following the drill path, including sequential drill selection, orientation, and depth verification during surgery. Additional features may be incorporated into embodiments to assist the user in identifying and selecting the correct drill component for a particular surgery.

The bone-level stopper 240 is configured to provide depth-control of the bone level guided drill 200. The bone-level stopper 240 can be configured so that the terminal diameter of the active shaft 230 (or hub region) is smaller than the cylindrical diameter of the guide shaft 220. The dimensional offset causes the larger-diameter guide shaft 220 to function as a stop when the guide shaft 220 contacts, touches, and/or engages the tissue of the patient, such as the bone, or more specifically the superior cortical surface of the bone.

The superior cortical surface of the bone refers to the outermost, hard layer of bone that the user first encounters when creating an osteotomy. Cortical bone is the dense, strong outer shell of the jawbone. Superior surface refers to the topmost portion of the cortical layer at the site where the drill component enters the bone.

At the point of contact between the bone-level stopper 240 and the active shaft 230, the drill path has been achieved, and both the depth and width of the osteotomy (or aperture/hole within the bone/tooth) corresponds with the drill path. The bone level guided drill 200 prevents further advancement of the drill and ensures that the osteotomy terminates exactly at the intended depth dictated by the drill path. The bone level guided drill 200 allows the predetermined drill path to be followed without external gauges, spacers, or depth measurements. The only depth calculation required is the distance from the top surface of the cortical bone to the intended implant depth. In contrast, prior-art systems typically require external gauges, spacers, or additional depth-measurement steps, which introduce complexity and increase the likelihood of error.

The bone-level stopper 240 can be configured to enable consistent, repeatable, and minimally invasive guided drilling with enhanced surgical efficiency. The bone-level stopper 240 can eliminate the need for separate calibration instruments, minimizes procedural error, and provides reliable bone-level precision for various drill components, including surgeries where multiple drill components are employed as per the drill path.

Embodiments can include a bone level guided drill including an engaging shaft, a guide shaft, wherein the guide shaft can include a guide shaft interior channel, a guide shaft locking component; an active shaft, wherein the active shaft can include an active shaft extension, and the diameter of the guide shaft is greater than the diameter of the active shaft; and a bone-level stopper, wherein the bone-level stopper can be configured to stop the downward progress of the active shaft via the engagement of the bone-level stopper with the surface of the bone of a patient, wherein the guide shaft interior channel can be configured to receive the active shaft extension, the guide shaft locking component can be configured to maintain the active shaft extension at a pre-set position within the guide shaft interior channel, and the pre-set position within the guide shaft interior channel can be configured to stop the downward progress of the active shaft via the bone-level stopper at a pre-set depth.

The bone-level stopper 240 may be manufactured in various diameters and widths to accommodate different cortical bone thicknesses and guide sleeve heights. In certain embodiments, the bone-level stopper 240 may be removable or interchangeable, allowing the same drill body to adapt to variable sleeve guide geometries and/or depth protocols. The contacting surfaces of the bone level guided drill 200, which can include the external walls of the guide shaft 220, the surfaces of the bone-level stopper 240, and the internal walls of the guide sleeves (which is not a part of the bone level guided drill 200) may be tapered, radiused, or chamfered to promote smooth engagement with the cortical bone or sleeve guide surface and to prevent gouging or binding during contact.

Optional design features for the bone-level stopper 240 can include color-coding for quick identification of drill length or series, and axial relief grooves or irrigation channels incorporated into the bone-level stopper 240 to facilitate coolant flow and debris evacuation during drilling. The bone-level stopper 240 can be fabricated from surgical-grade stainless steel or titanium alloy, or from a differentially hardened or coated material to improve wear resistance and maintain consistent dimensional integrity after multiple sterilization cycles.

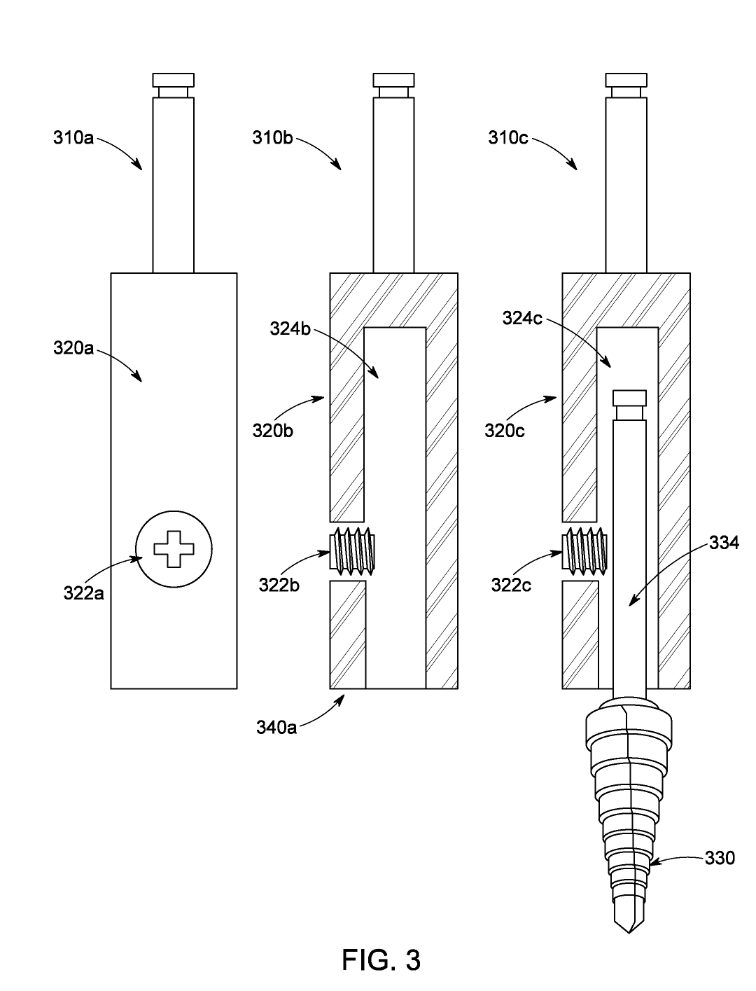

FIG. 3 illustrates three views of the bone level guided drill 300a, b, c according to an embodiment. The bone level guided drill 300a, b, c as illustrated in FIG. 3 illustrates the active shaft extension 334 that extends from an edge of the active shaft 330 adjacent to the guide shaft 320 into the interior of the guide shaft 320. The active shaft extension 334 is configured to adjust the depth of the drill component 332. Additionally, the active shaft extension 334 allows for easy removal and replacement of alternative active shafts 330a-d with different active features.

The active shaft extension 334 is configured to be inserted into the guide shaft interior channel 324. The guide shaft interior channel 324 is configured to receive the active shaft extension 334 and hold the active shaft extension 334 firmly and securely within the guide shaft 320.

A guide shaft locking component 322 is configured to secure the active shaft extension 334 within the guide shaft interior channel 324. The guide shaft locking component 322 can be a chuck, collet-style coupling system, screw, latch, compression sleeve, spring-loaded latch, or threaded coupling system configured provide a firm locking of the active shaft extension 334 while maintaining axial stability of the bone level guided drill 300.

The depth of the drilling (or other activity) of the bone level guided drill 300 is controlled by the total distance between the bone level stopper 340 and the distal edge of the active shaft 342. This distance can be controlled by the placement of the active shaft extension 334 within the guide shaft interior channel 324. The stopping of the drilling (or other activity) occurs with the top surface of the bone (or tissue) comes in contact with the bone level stopper 340 of the bone level guided drill 300.

The embodiment enables rapid interchange of active shafts without removing the guide shaft, which improves surgical efficiency and reduces surgical tray complexity.

The embodiment maintains exact trajectory and depth reference throughout sequential drilling or expansion procedures.

The embodiment provides customization by supporting multiple active shafts, for example cutting, condensing, or transporting, within a single bone level guided drill.

The embodiment reduces instrument load by minimizes the number of complete drills required while extending clinical versatility.

The embodiment enhances safety because the locking component 322 The locking system and bone level stopper 340 prevent over-insertion and ensure controlled depth delivery.

The embodiment can be used during guided implant site preparation where multiple sequential operations, such as pilot drilling, shaping, bone condensation, and/or particulate delivery, are performed according to a predetermined drill path.

The embodiment allows surgeons to switch between specialized active shafts 330 while maintaining precise bone-level depth and angulation, thereby optimizing procedural control, workflow efficiency, and instrument economy.

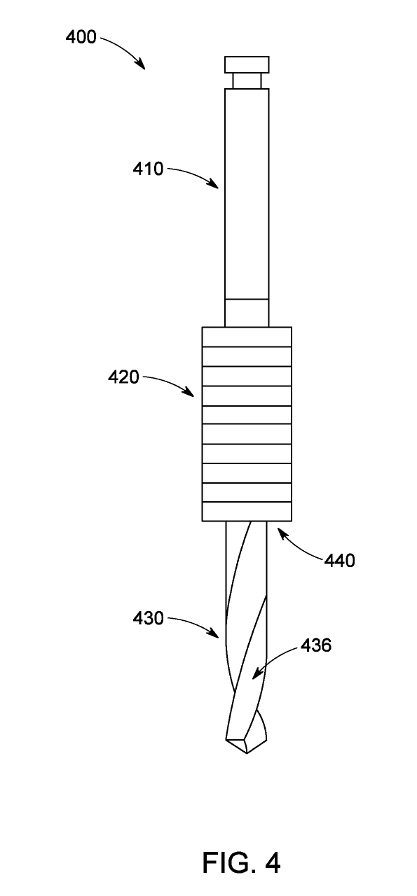

FIG. 4 illustrates a bone level guided drill 400 with a straight active drill shaft 430. The bone level guided drill 400 includes an engaging shaft 410, a guide shaft 420, a straight active shaft 430, and a bone-level stopper 440. Optionally, the bone level guided drill 400 can further include an eyelet (not shown).

The straight active drill shaft 430 is configured with straight flutes 436 arranged parallel to the longitudinal axis of the bone level guided drill 400. This geometry promotes efficient chip evacuation, controlled torque transmission, and precise dimensional control of the osteotomy. The straight-flute configuration is particularly advantageous for initial pilot drilling and bone shaping in dense cortical zones, offering excellent directional stability and reduced lateral deviation. The active shaft 430 may be prepared and/or fabricated in multiple diameters and lengths corresponding to sequential drill stages, each calibrated to the digital surgical plan. Optional color coding or laser-engraved depth indicators may be provided for easy identification within a surgical kit.

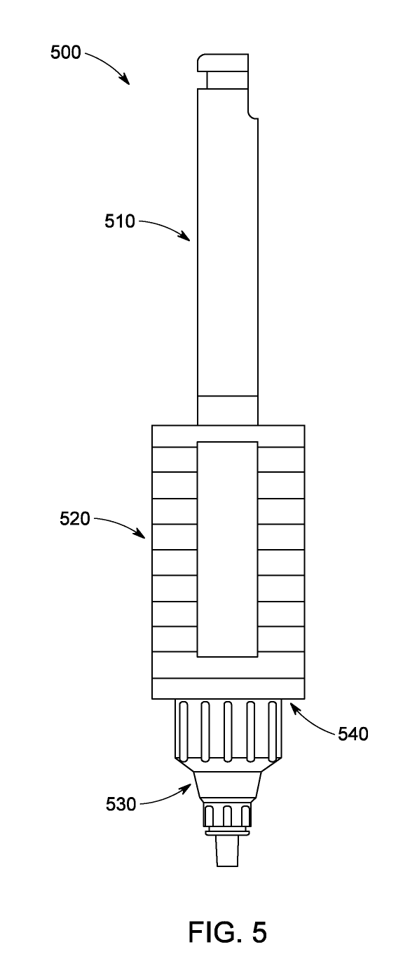

FIG. 5 illustrates a bone level guided drill 500 with an implant insertion active shaft 530. The bone level guided drill 500 includes an engaging shaft 510, a guide shaft 520, an implant insertion active shaft 530, and a bone-level stopper 540. Optionally, the bone level guided drill 500 can further include an eyelet (not shown).

Embodiments can be configured to deliver a dental implant through the surgical guide with precise depth and angular control, ensuring the implant is seated exactly at the planned bone level.

The implant insertion active shaft 530 can be configured to engage various implant’s coronal connection interface, for example internal hex, external hex, conical, or morse-taper type. The implant insertion active shaft 530 can transmits both seating force and rotational torque concentrically through the guide sleeve to the implant. The implant insertion active shaft 530 can be configured to accommodate implant with indexing flats, splines, or hexagonal posts that correspond to the implant’s mating interface, ensuring positive engagement and zero rotational slippage. In certain embodiments, the active shaft may feature modular or replaceable driver tips, allowing the same bone level guided drill 500 to service multiple implant platforms.

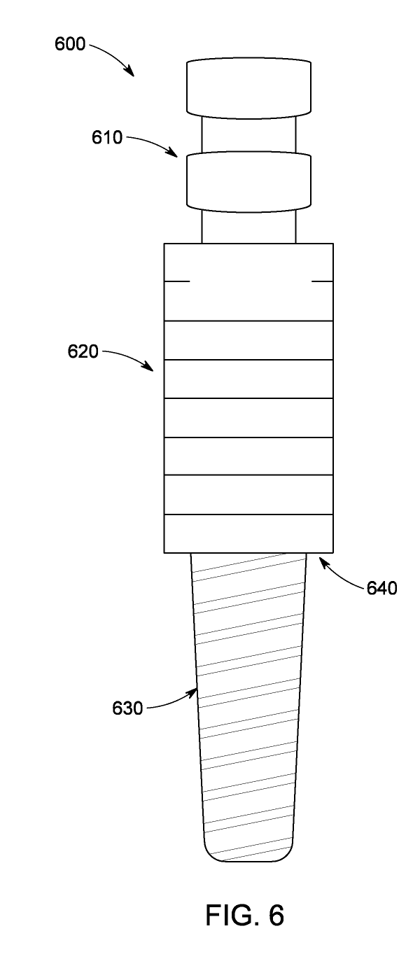

FIG. 6 illustrates a bone level guided drill 600 with a bone expander active shaft 630. The bone level guided drill 600 includes an engaging shaft 610, a guide shaft 620, a tapered active drill shaft 630, and a bone-level stopper 640. Optionally, the bone level guided drill 800 can further include an eyelet (not shown).

The embodiment shown in FIG. 6 is a precision-engineered instrument configured for controlled lateral bone expansion and compaction during guided implant osteotomy.

The bone expander active shaft 630 can be configured with a screw-shaped or conical working section featuring non-cutting threads configured to expand and condense bone rather than remove it.

The tip of the bone expander active shaft 630 may be rounded and atraumatic to gently expand cortical or cancellous bone while safeguarding adjacent anatomical structures such as the sinus membrane or neurovascular bundles. Alternatively, a concave tip may be used to compact and convey particulate graft material into the osteotomy or sinus cavity during augmentation.

The bone expander active shaft 630 can be employed in a sequential use in a graduated series of diameters. The surgeon or user can initiates expansion with a pilot osteotomy and proceeds through progressively larger expanders, achieving controlled ridge widening with minimal trauma.

The bone expander active shaft 630 can provide ridge widening, which gradually displaces and reshapes narrow alveolar ridges to create adequate width for implant placement without removing vital bone.

The bone expander active shaft 630 can provide bone densification, for example, in areas of low bone density, such as the maxilla, the non-cutting threads of the bone expander active shaft 630 can compact trabecular bone, enhancing its density.

The bone expander active shaft 630 can provide implant stability because the densified, precisely formed socket significantly improves primary stability, a critical determinant of long-term osseointegration.

The thread pitch, depth, and conical taper of the bone expander active shaft 630 can be configured to accommodate variations in bone density and desired expansion rates.

Following completion of a pilot and shaping drill sequence, the bone expander active shaft 630 can be employed to progressively expand the osteotomy, particularly in narrow ridges or sites exhibiting low bone density. The bone expander active shaft 630 can provide atraumatic ridge widening and condensation, preserving bone vitality while optimizing implant stability, thereby eliminating the need for osteotomes or lateral ridge-splitting procedures.

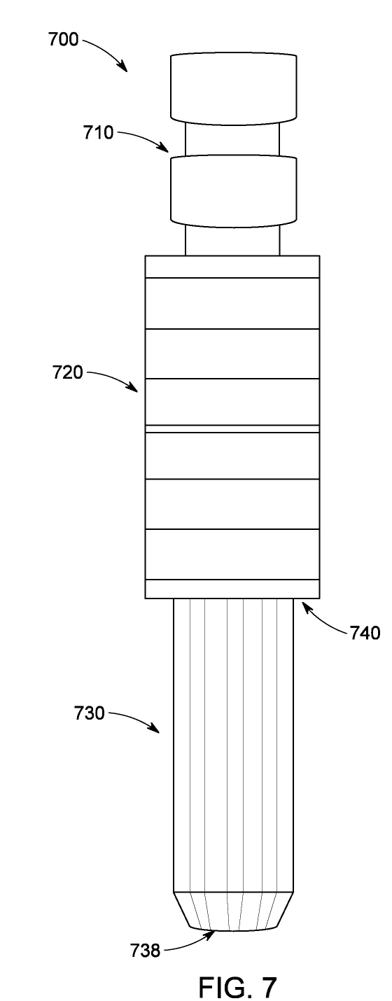

FIG. 7 illustrates a bone level guided drill 700 with a tissue punch active shaft 730. The bone level guided drill 700 includes an engaging shaft 710, a guide shaft 720, a tapered active drill shaft 730, and a bone-level stopper 740. Optionally, the bone level guided drill 700 can further include an eyelet (not shown).

The embodiment shown in FIG. 7 is configured to provide a precision surgical instrument designed for atraumatic soft-tissue removal in guided implant procedures. The embodiment is configured to provide flapless access through the surgical guide, creating a circular opening in the mucosa precisely at the implant site while preserving surrounding keratinized tissue.

The tissue punch active shaft 730 is configured as a hollow, cylindrical cutting element with a razor-sharp, beveled edge at its apical rim 738. The tissue punch active shaft 730 can be configured to incise and detach soft tissue rather than bone. The apical rim 738 can be a circular cutting edge configured to produces a clean, precise soft-tissue opening as directed by the drill path of the planned osteotomy, minimizing trauma and ensuring accurate guide positioning.

The hollow lumen (not shown) of the tissue punch active shaft 730 can be configured to collect the excised tissue plug for easy removal and inspection. Alternative shapes of the tissue punch active shaft 730 can include micro-serrated bevels or variable edge angulation to optimize cutting efficiency in dense or fibrotic mucosa.

The tissue punch active shaft 730 can provide flapless access by creating a soft-tissue opening through the surgical guide without raising a flap, minimizing postoperative discomfort and swelling.

The tissue punch active shaft 730 can provide preservation of keratinized tissue because the circular incision can confine removal of tissue strictly to the implant site, maintaining the integrity of adjacent gingiva.

The tissue punch active shaft 730 can reduce surgical time by eliminates the need for scalpel incisions and suturing.

The tissue punch active shaft 730 can provide enhanced guide accuracy via ensures full seating of the surgical guide at the mucosal surface, supporting accurate osteotomy depth and angulation.

The tissue punch active shaft 730 can be employed at the initial stage of guided implant surgery, for example the tissue punch active shaft 730 can be used immediately prior to the pilot drill to expose the underlying bone through a minimally invasive approach. The atraumatic cutting action and depth control (provided by the bone level stopper 740) can preserve soft-tissue architecture and enhance the precision, efficiency, and comfort of guided implant placement.

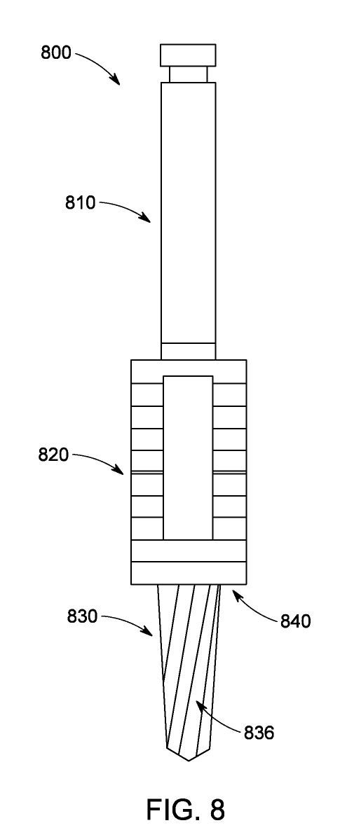

FIG. 8 illustrates a bone level guided drill 800 with a tapered active drill shaft 830. The bone level guided drill 800 includes an engaging shaft 810, a guide shaft 820, a tapered active drill shaft 830, and a bone-level stopper 840. Optionally, the bone level guided drill 800 can further include an eyelet (not shown).

The tapered active shaft 830 is configured for controlled bone shaping and osteotomy enlargement while maintaining a consistent depth and trajectory.

The tapered active shaft 830 can be configured with a progressively tapered profile, decreasing in diameter toward the distal end of the active shaft 832. Flutes 836 can be present from 1 to 10, 3 to 9, or 4 to 6 flutes 836 per active shaft 832 (depending on the taper and diameter of the active section 832). The flutes 836 can be configured to gradually expand the osteotomy from the pilot diameter to the desired implant platform size. Preferably the flues 836 are helical.

The flute 836 are configured to removes small, controlled volumes of bone, allowing for reduced mechanical stress on the bone (such as the cortical and cancellous structures), lower heat generation during osteotomy, and provide minimal vibration and patient discomfort.

The flute 836 can be dual, triple, quadruple, or quintuple helical arrangements optimized for efficient debris evacuation under irrigation. Shallow flutes and a progressive taper minimize friction, chatter, and torque resistance.

The bone level guided drill 800 can be configured to be self-centering allowing the next active shaft in the sequence to engage passively, often advancing approximately one-third of the drill length into the osteotomy prepared by the preceding drill before rotational activation. This ensures that each subsequent active shaft automatically follows the trajectory of the drill path, enabling continued shaping even after only the pilot step has been performed under guidance.

The tapered profile also facilitates anatomical contouring of osteotomy walls, particularly in narrow or convergent alveolar ridges, while maintaining cortical support and optimal implant bed morphology.

During guided implant surgery, the tapered active shaft 839 can be introduced through the guide sleeve following a pilot drill step. The free-glide mechanism permits smooth advancement until the bone-level stopper contacts the cortical surface, ensuring precise depth control and trajectory fidelity consistent with the pre-planned drill path.

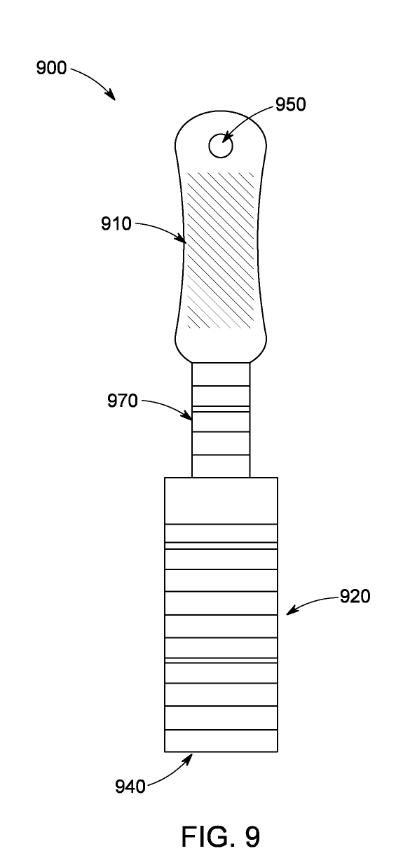

FIG. 9 illustrates a bone level reference gauge 900 with an eyelet 950. The bone level reference gauge 900 can includes a handle 910, a guide shaft 920, and a bone-level stopper 940. The embodiment shown does not depict an active shaft.

The eyelet 950 can be a perforated opening or aperture configured to allow threading of dental floss or retrieval wire to prevent accidental loss, swallowing, or aspiration of a bone level reference gauge 900 and to allow secure retrieval during intraoral use.

The handle 910 can further include grip features configured to provide controlled manipulation.

The bone level reference gauge 900 can be a precision depth-measuring and positioning instrument configured to determine and verify the vertical relationship between the surface of the bone and a prosthetic platform level during guided implant surgery. bone level reference gauge 900 can serve as an auxiliary tool within a kit for the bone level guided drill according to prior embodiments and can integrates seamlessly with the accompanying surgical guides and sleeves.

The bone level reference gauge 900 can provide a rapid, reproducible method to assess implant depth relative to the bone crest, before, during, or after surgery, such as an osteotomy preparation, which can ensure consistent vertical alignment across multiple implant sites.

The bone level reference gauge 900 can incorporates coordinated components configured for ergonomic control, precision measurement, and surgical safety.

The bone level reference gauge 900 can include a handle 910 that can be configured with an ergonomically contoured handle with variable shapes and diameters. The diameters can vary from approximately 3 to 15 mm. The handle 910 can include a grip element that provides a secure grip and tactile feedback even under irrigation or glove moisture. The handle 910 can further include surface textures or micro-grooves configured to enhance anti-slip control while maintaining cleanability under sterilization.

The guide shaft 920 can be configured to be slender with a precision-machined cylindrical shaft with a length of approximately 3 to 35 mm and a diameter of approximately 2 to 15 mm. The guide shaft 920 can be configured to glides freely through a guide sleeve or measurement sleeve. The guide shaft 920 can establish a fixed vertical reference line corresponding to the osteotomy axis and ensure friction-controlled movement for accurate depth positioning.

The vertical connector 970 can be an intermediate segment joining the handle 910 and the guide shaft 920. The vertical connector 970 can have a length of approximately 3 to 15 mm. The vertical connector 970 can maintains mechanical rigidity while allowing ergonomic offset between handle 910 and guide shaft 920 to accommodate posterior access or limited inter-arch space.

The bone level stopper 940 is configured to halts the bone level reference gauge 900 at the bone surface (such as the cortical bone surface). This mechanical stop defines the bone crest reference point, allowing the user/surgeon to visualize or measure the distance from bone to platform or sleeve margin with precision.

The bone level reference gauge 900 can include laser-etched or micro-grooved markings, or graduation lines of variable spacing and depth to provide precise millimeter-scale measurements. The markings may be circumferential or longitudinal, enabling both vertical and angular assessment of the implant platform relative to the bone crest.

Optional handle knurling or matte finishing may be applied for improved grip. The overall length of the bone level reference gauge 900 can be between approximately 10 to 45 mm. The length of the bone level reference gauge 900 can be varied to suit specific clinical protocols and guide sleeve depths.

The bone level reference gauge 900 provides precise vertical referencing. The bone level reference gauge 900 can establishes the exact bone-to-platform distance to guide implant depth decisions.

The bone level reference gauge 900 can provide inter-site consistency and enables uniform depth verification across multiple implants. The built-in bone level stopper 940 is configured to prevent over-insertion, while the eyelet 950 minimizes the risk of intraoral loss. The compact design of the bone level reference gauge 900 can allows effortless intraoral manipulation, including posterior sites with limited vertical clearance.

The bone level reference gauge 900 can be configured to provide verification and calibration throughout the guided implant/drilling process, for example, before drilling (for bone mapping), during drilling (for real-time depth control), and after implant placement (for final bone-level confirmation).

The precise mechanical stop and calibrated markings of the bone level reference gauge 900 can provide an accurate and repeatable method to ensure each implant achieves the planned crestal bone alignment, improving prosthetic predictability and long-term peri-implant tissue stability.

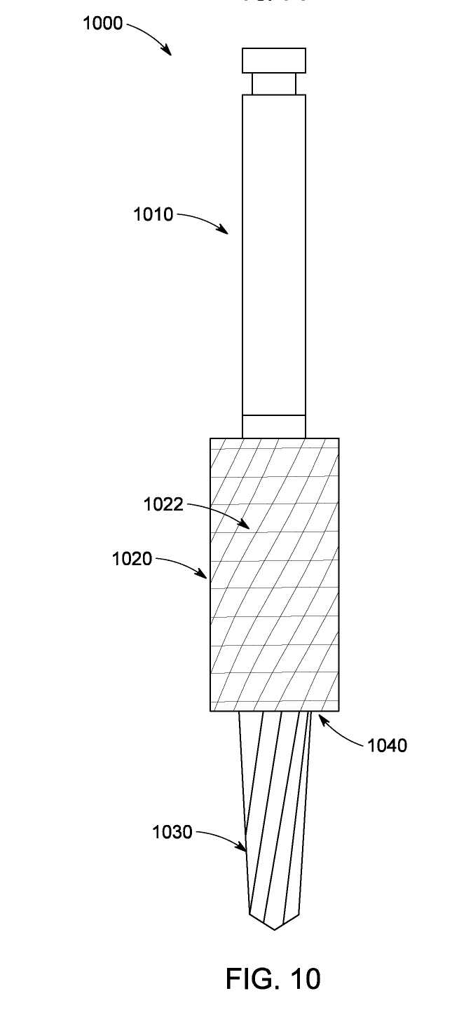

FIG. 10 illustrates an alternative bone level guided drill 1000 with a tapered active drill shaft 1030. The bone level guided drill 1000 includes an engaging shaft 1010, a guide shaft 1020, a tapered active drill shaft 1030, and a bone-level stopper 1040. Optionally, the bone level guided drill 1000 can further include an eyelet (not shown).

The tapered active shaft 1030 is configured for controlled bone shaping and osteotomy enlargement while maintaining a consistent depth and trajectory. The alternative bone level guided drill 1000 differs from the bone level guided drill 800 via the grooves 1022. The grooves 1022 can be helicoidal or vertical. The grooves 822 are not cutting features, they alternatively provide micro-channels that reduce surface contact between the guide shaft 1020 and guide sleeve (not shown). The micro-channels assist with avoiding sticking or rotational resistance when heat or debris accumulate during drilling (or other active features of the bone level guided drill 1000). Further, the micro-channels can direct irrigation toward the osteotomy, enhancing thermal regulation near the bone and lowering heat generation at the drill/sleeve interface.

Additionally, in situations where there can be bone chipping from drilling, irrigation fluid can move upward through the channels 1022 can debris is then less likely to accumulate between the guide shaft 1020 and sleeve (now shown). The channels 1022 allow the bone level guided drill 1000 to maintain smooth rotation and minimizes wear.

Further, the grooves 1022 can preserving sleeve geometry and maintaining angular accuracy by decreasing friction and sleeve wear over repeated uses. Further, the grooves 1022 can reduce binding, which improves the tactile feel during drilling allowing the user/surgeon to perceive torque and density changes while maintaining guided control.

FIG. 11 illustrates a bone level reference probe 1100, according to an embodiment. The bone level reference probe 1100 can include a guide shaft 1120, a reference handle 1110, a bone level stopper 1140, and a guide shaft connector assembly 1170.

The bone level reference probe 1100 is a depth-verification instrument, that can be combined in a kit with the bone level guided drill of the prior embodiments of the present invention. The bone level reference probe 1100 can confirm the vertical position of the crestal bone relative to the drill path during guided implant surgery.

The bone level reference probe 1100 can be a precision-engineered instrument configured to verify and calibrate the vertical position of the crestal bone relative to the prosthetic reference plane during guided implant surgery. The bone level reference probe 1100 forms an integral component of the bone level guided drill kit and is fully compatible with the accompanying surgical guides and sleeve configurations. The bone level reference probe 1100 can provide a direct mechanical and visual reference for determining bone level depth after flap reflection or during flapless guided procedures, ensuring accurate measurement and consistent implant seating at the pre-planned bone height.

The bone level reference probe 1100 can be prepared, manufactured and/or constructed using the materials defined above for the bone level guided drill. The bone level reference probe 1100 can includes a guide shaft 1120 that can be precision-machined. The guide shaft 1120 can be configured to glide freely within a guide sleeve. The guide shaft 1120 can includes marking 1122, such as laser-etched or micro-grooved millimeter markings that can provide direct visual indication of bone height when the bone level reference probe 1100 engaged with the surface of the bone or tissue.

A bone level stopper 1140 can be positioned at the end of the guide shaft 1120 opposite the reference handle 1110. When advanced through the surgical guide, bone level stopper 1140 can mechanically halts downward travel (or progress) at the surface of the bone or tissue, establishing a repeatable reference point for bone-level measurement that corresponds to a planned drill path.

The depth reference can be obtained without additional measuring instruments or external spacers.

The reference handle 1110 can be ergonomically shaped and incorporates gripping components, such as anti-slip surface features to ensure firm control even under irrigation. Variations in handle taper and diameter can support balanced weight distribution and user comfort when accessing posterior regions or limited inter-arch space.

During oral surgery, the bone level reference probe 1100 can be introduced through a guide sleeve until the bone-level stopper 1140 contacts the surface of the bone or tissue. The visible millimeter markings on the guide shaft 1120 can then indicate the vertical distance between the bone surface and an implant. This allows the surgeon to verify or adjust implant depth before, during, or after surgery, such as osteotomy preparation, which can support consistent drilling, implants, and other procedures.

The guide shaft 1120 can be approximately 5 to 50 mm in length. The guide shaft 1120 can be a smooth precision-machined shaft configured to glide through a guide sleeve with minimal friction. The guide shaft 1120 can be configured to have free-glide tolerance to ensures stable axial control while allowing unimpeded motion for depth verification.

The guide shaft can have a diameter of 3-12 mm. The diameter of the guide shaft can be adjustable to accommodate guide sleeves of variable inner diameters. Bone level reference probe can be produced in multiple sizes to match distinct surgical protocols and sleeve systems.

The guide shaft connector assembly 1170 connects, joins and/or links the guide shaft 1120 and the reference handle 1110. The guide shaft connector assembly 1170 can be configured as a straight horizontal connector or a horizontal offset connector (as shown in FIG. 11), which providing ergonomic clearance and optimized line-of-sight in posterior or angled regions. The guide shaft connector assembly 1170 can allow the reference handle 1110 and the guide shaft 1120 to have a predefined angular offset which provides improved access to posterior segments and better visualization of the bone-level reference line.

The reference handle 1110 can further include grip enhancers 1112, such as anti-slip features, knurled, micro-textured, or longitudinally grooved handle surface for enhanced tactile grip and rotational control during measurement.

The reference handle 1110 can further include an extended handle with upper and lower taper zones to provide balanced weight distribution and operator comfort during repetitive use. The reference handle 1110 can include an upper taper transition into a lower taper, which can optimizing balance, minimizing obstruction within the surgical field, and ensure firm coupling to the guide shaft connector assembly 1170.

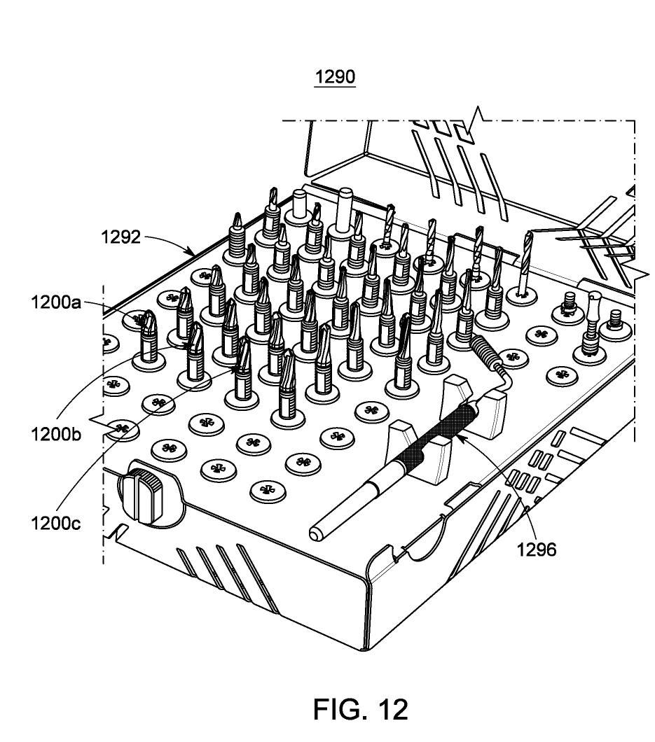

FIG. 12 illustrates a bone level guided drill kit 1290 holding multiple bone level guided drills 1200, according to an embodiment. FIG. 12 depicts a bone level guided drill kit 1290 including a plurality of bone level guided drills 1200 a-c (as depicted there are over twenty variations on the bone level guided drills 1200 in the holder 1292) with different active shafts, diameters and lengths arranged within a holder 1292. Each bone level guided drill 1200 a-c includes an active shaft 1240, an engaging shaft 1210 and a guide shaft 1220 configured for use with a surgical guide sleeve. Associated instruments are also shown stored within the holder 1292. The bone level guided drill kit 1290 is configured to maintain the bone level guided drills 1200a-c and associated instruments, such as a bone level reference probe 1296 and bone level reference gauge in an organized arrangement for use during guided surgical procedures.

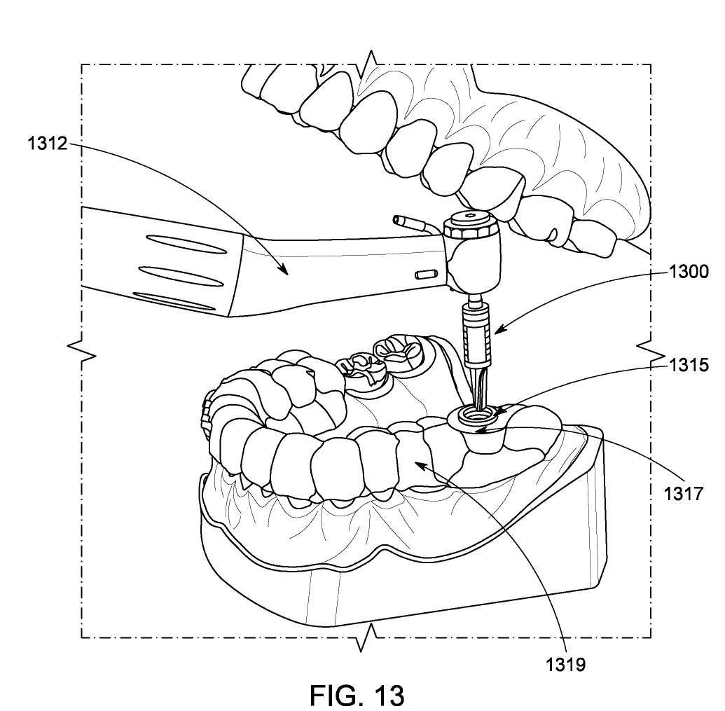

FIG. 13 illustrates a bone level guided drill 1300 attached to a driving instrument (or surgical handpiece) 1312, according to an embodiment. The bone level guided drill 1300 is depicted in use in a human mouth, according to an embodiment. FIG. 13 depicts a driving instrument 1312 holding a bone level guided drill 1300 aligned for entry into a guide sleeve 1315. The guide sleeve 1315 is a component of a surgical guide 1317 positioned within a dental arch 1319 and ready for use by a surgeon or user.

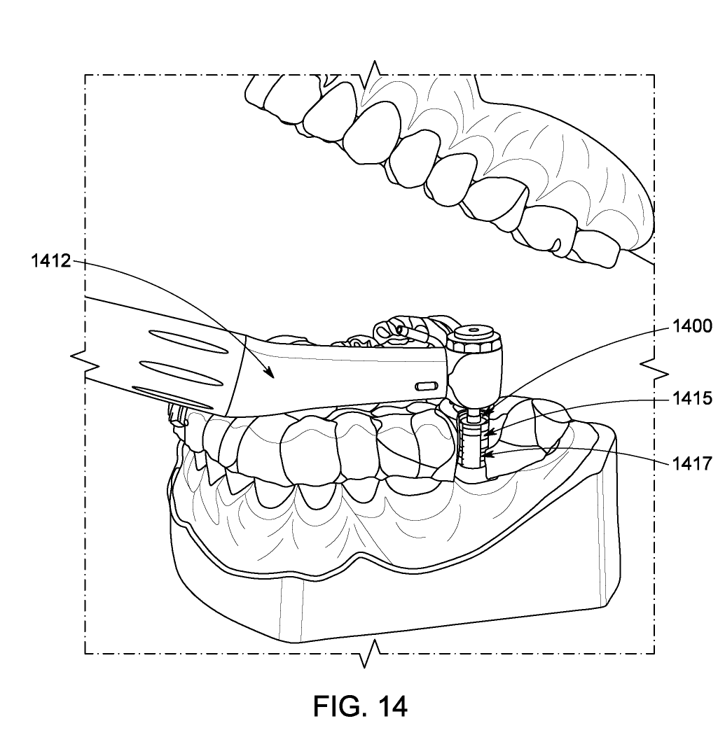

FIG. 14 illustrates a bone level guided drill 1400 attached to a driving instrument (or surgical handpiece) 1412 in use in a human mouth, according to an embodiment. FIG. 14 depicts a cut-away view of a guide sleeve 1415, wherein the bone level guided drill 1400 is depicted as moving through the guide sleeve 1415 and positioned at a final position within the surgical guide 1417. The bone level guided drill 1400 is stopped at the top of the bone surface by bone level stopper 1440 (not shown), preventing further advancement into the bone by the bone level guided drill 1400.

Embodiments can include a bone level guided drill including an engaging shaft, a guide shaft, wherein the guide shaft can include a guide shaft interior channel, a guide shaft locking component; an active shaft, wherein the active shaft can include an active shaft extension, and the diameter of the guide shaft is greater than the diameter of the active shaft; and a bone-level stopper, wherein the bone-level stopper can be configured to stop the downward progress of the active shaft via the engagement of the bone-level stopper with the surface of the bone of a patient, wherein the guide shaft interior channel can be configured to receive the active shaft extension, the guide shaft locking component can be configured to maintain the active shaft extension at a pre-set position within the guide shaft interior channel, and the pre-set position within the guide shaft interior channel can be configured to stop the downward progress of the active shaft via the bone-level stopper at a pre-set depth.

Embodiment can include a bone level guided drill wherein the active shaft can be a straight drill active shaft.

Embodiment can include a bone level guided drill wherein the active shaft can be an implant insertion active shaft.

Embodiment can include a bone level guided drill wherein the active shaft can be a bone expander active shaft.

Embodiment can include a bone level guided drill wherein the active shaft can be a tissue punch active shaft.

Embodiment can include a bone level guided drill wherein the active shaft can be a tapered shaping bone level guided drill.

Embodiment can include a bone level guided drill wherein marking on the guide shaft can be configured to provide depth reference for the user.

Embodiment can include a bone level guided drill wherein the bone level guided drill can be configured to fit within a guide sleeve, and the guide sleeve is constructed via a pre-determined drill path.

Embodiments can include a method of providing an osteotomy comprising creating a drill path based on the treatment required by a patient, choosing a selection of bone level guided drills based on the drill path, attaching a bone level guided drill to a driving instrument, attaching a guide sleeve to the bone of a patient based on a pre-set drill path, employing the bone level guided drill to assist the osteotomy via the driving instrument, wherein the bone level guided drill operates within the guide sleeve.

Embodiments can include a method wherein a second bone level guided drill is employed, and wherein the first bone level guided drill comprised a straight drill active shaft, the second bone level guided drill comprises an implant insertion active shaft.

Embodiments can include a method wherein a third bone level guided drill is employed, and wherein the third bone level guided drill is a bone expander active shaft.

Embodiments can include a method wherein a fourth bone level guided drill is employed, and wherein the fourth bone level guided drill is a tissue punch active shaft.

Embodiments can include a method wherein the drill path is determined via assistance of data from the patient and pre-set drill paths based on the required surgery.

Embodiments can include a method wherein difference in with between the guide sleeve and the bone level guided drill are between 0.02 mm and 0.05 mm.

Embodiments can include a kit including a first bone level guided drill, wherein the first bone level guided drill can include a straight drill active shaft, a second bone level guided drill, wherein the second bone level guided drill can include an implant insertion active shaft, a third bone level guided drill, wherein the third bone level guided drill can include a bone expander active shaft, a fourth bone level guided drill, wherein the fourth bone level guided drill can include a tissue punch active shaft, a fifth bone level guided drill, wherein the fifth bone level guided drill can include a tapered shaping bone level guided drill, a bone level reference probe, and a bone level reference gauge.

Embodiments can include a kit including wherein the bone level reference gauge further comprises an eyelet, and wherein the eyelet is configured to allow dental floss to secure the bone level reference gauge and avoid accidental aspiration via the patient.

Embodiments can include a kit including wherein the bone level guided drills comprise guide shafts further comprising helicoidal grooves.

Embodiments can include a kit wherein the bone level guided drills comprise guide shafts further comprising millimeter markings.

Embodiments can include a kit including wherein bone level reference probe can include a tapered handle with a gripping component.

A feature illustrated in one of the figures may be the same as or similar to a feature illustrated in another of the figures. Similarly, a feature described in connection with one of the figures may be the same as or similar to a feature described in connection with another of the figures. The same or similar features may be noted by the same or similar reference characters unless expressly described otherwise. Additionally, the description of a particular figure may refer to a feature not shown in the particular figure. The feature may be illustrated in and/or further described in connection with another figure.

Elements of processes (i.e. methods) described herein may be executed in one or more ways such as by a human, by a processing device, by mechanisms operating automatically or under human control, and so forth. Additionally, although various elements of a process may be depicted in the figures in a particular order, the elements of the process may be performed in one or more different orders without departing from the substance and spirit of the disclosure herein.

The foregoing description sets forth numerous specific details such as examples of specific systems, components, methods and so forth, in order to provide a good understanding of several implementations. It will be apparent to one skilled in the art, however, that at least some implementations may be practiced without these specific details. In other instances, well-known components or methods are not described in detail or are presented in simple block diagram format in order to avoid unnecessarily obscuring the present implementations. Thus, the specific details set forth above are merely exemplary. Particular implementations may vary from these exemplary details and still be contemplated to be within the scope of the present implementations.

Related elements in the examples and/or embodiments described herein may be identical, similar, or dissimilar in different examples. For the sake of brevity and clarity, related elements may not be redundantly explained. Instead, the use of a same, similar, and/or related element names and/or reference characters may cue the reader that an element with a given name and/or associated reference character may be similar to another related element with the same, similar, and/or related element name and/or reference character in an example explained elsewhere herein. Elements specific to a given example may be described regarding that particular example. A person having ordinary skill in the art will understand that a given element need not be the same and/or similar to the specific portrayal of a related element in any given figure or example in order to share features of the related element.

It is to be understood that the foregoing description is intended to be illustrative and not restrictive. Many other implementations will be apparent to those of skill in the art upon reading and understanding the above description. The scope of the present implementations should, therefore, be determined with reference to the appended claims, along with the full scope of equivalents to which such claims are entitled.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements.

As used herein “same” means sharing all features and “similar” means sharing a substantial number of features or sharing materially important features even if a substantial number of features are not shared. As used herein “may” should be interpreted in a permissive sense and should not be interpreted in an indefinite sense. Additionally, use of “is” regarding examples, elements, and/or features should be interpreted to be definite only regarding a specific example and should not be interpreted as definite regarding every example. Furthermore, references to “the disclosure” and/or “this disclosure” refer to the entirety of the writings of this document and the entirety of the accompanying illustrations, which extends to all the writings of each subsection of this document, including the Title, Background, Brief description of the Drawings, Detailed Description, Claims, Abstract, and any other document and/or resource incorporated herein by reference.

As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. An example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

Where multiples of a particular element are shown in a FIG., and where it is clear that the element is duplicated throughout the FIG., only one label may be provided for the element, despite multiple instances of the element being present in the FIG. Accordingly, other instances in the FIG. of the element having identical or similar structure and/or function may not have been redundantly labeled. A person having ordinary skill in the art will recognize based on the disclosure herein redundant and/or duplicated elements of the same FIG. Despite this, redundant labeling may be included where helpful in clarifying the structure of the depicted examples.

The Applicant(s) reserves the right to submit claims directed to combinations and sub-combinations of the disclosed examples that are believed to be novel and non-obvious. Examples embodied in other combinations and sub-combinations of features, functions, elements and/or properties may be claimed through amendment of those claims or presentation of new claims in the present application or in a related application. Such amended or new claims, whether they are directed to the same example or a different example and whether they are different, broader, narrower or equal in scope to the original claims, are to be considered within the subject matter of the examples described herein.

1. A bone level guided drill comprising:
an engaging shaft,
a guide shaft,
wherein the guide shaft comprises:
a guide shaft interior channel, and
a guide shaft locking component,
an active shaft,
wherein the active shaft comprises:
an active shaft extension, and
the diameter of the guide shaft is greater than the diameter of the active shaft; and
a bone-level stopper,
wherein the bone-level stopper is configured to stop the downward progress of the active shaft via the engagement of the bone-level stopper with the surface of the bone of a patient,
wherein:
the guide shaft interior channel is configured to receive the active shaft extension,
the guide shaft locking component is configured to maintain the active shaft extension at a pre-set position within the guide shaft interior channel, and
the pre-set position within the guide shaft interior channel is configured to stop the downward progress of the active shaft via the bone-level stopper at a pre-set depth.

2. The bone level guided drill of claim 1, wherein:
the active shaft is a straight drill active shaft.

3. The bone level guided drill of claim 1, wherein:
the active shaft is an implant insertion active shaft.

4. The bone level guided drill of claim 1, wherein:
the active shaft is a bone expander active shaft.

5. The bone level guided drill of claim 1, wherein:
the active shaft is a tissue punch active shaft.

6. The bone level guided drill of claim 1, wherein:
the active shaft is a tapered shaping bone level guided drill.

7. The bone level guided drill of claim 1, wherein the active the active shaft further comprises grooves.

8. The bone level guided drill to claim 1 further comprising:
marking on the guide shaft configured to provide depth reference for the user.

9. The bone level guided drill of claim 1,
wherein:
the bone level guided drill is configured to fit within a guide sleeve,
the guide sleeve is constructed via a pre-determined drill path.

10. A method of providing an osteotomy comprising:
creating a drill path based on the treatment required by a patient,
choosing a selection of bone level guided drills based on the drill path,
attaching a bone level guided drill to a driving instrument,
attaching a guide sleeve to the bone of a patient based on a pre-set drill path, and
employing the bone level guided drill to assist the osteotomy via the driving instrument,
wherein the bone level guided drill operates within the guide sleeve.

11. The method of claim 10 wherein:
a second bone level guided drill is employed, and wherein the first bone level guided drill comprised a straight drill active shaft, the second bone level guided drill comprises an implant insertion active shaft.

12. The method of claim 11 wherein:
a third bone level guided drill is employed, and wherein the third bone level guided drill is a bone expander active shaft.

13. The method of claim 12 wherein:
a fourth bone level guided drill is employed, and wherein the fourth bone level guided drill is a tissue punch active shaft.

14. The method of claim 10 wherein the drill path is determined via assistance of data from the patient and pre-set drill paths.

15. The method of claim 10 wherein difference in with between the guide sleeve and the bone level guided drill are between 0.02 mm and 0.05 mm.

16. A kit comprising:
a first bone level guided drill,
wherein the first bone level guided drill comprises a straight drill active shaft,
a second bone level guided drill,
wherein the second bone level guided drill comprises an implant insertion active shaft,
a third bone level guided drill,
wherein the third bone level guided drill comprises a bone expander active shaft,
a fourth bone level guided drill,
wherein the fourth bone level guided drill comprises a tissue punch active shaft,
a fifth bone level guided drill,
wherein the fifth bone level guided drill comprises a tapered shaping bone level guided drill,
a bone level reference probe, and
a bone level reference gauge.

17. The kit of claim 16 wherein the bone level reference gauge further comprises an eyelet, wherein the eyelet is configured to allow dental floss to secure the bone level reference gauge and avoid accidental aspiration via the patient.

18. The kit of claim 16 wherein:
the bone level guided drills comprise guide shafts further comprising helicoidal grooves.

19. The kit of claim 16 wherein:
the bone level guided drills comprise guide shafts further comprising millimeter markings.

20. The kit of claim 16 wherein:
bone level reference probe comprises a tapered handle with a gripping component.
